(19) United States
(12) Patent Application Publication
(10) Pub. No.: US 2013/0109385 A1
(43) Pub. Date: May 2, 2013

(54) METHOD, APPARATUS, AND SYSTEM FOR LOCATING CO-LAYER NETWORK, MULTI-RADIO ACCESS TECHNOLOGY SERVING BASE STATION IDENTIFICATION

(71) Applicants: Steven D. Cheng, San Diego, CA (US); Guangming Shi, San Diego, CA (US); Kuo-Chun Lee, San Diego, CA (US); Tom Chin, San Diego, CA (US)

(72) Inventors: Steven D. Cheng, San Diego, CA (US); Guangming Shi, San Diego, CA (US); Kuo-Chun Lee, San Diego, CA (US); Tom Chin, San Diego, CA (US)

(73) Assignee: QUALCOMM Incorporated, San Diego, CA (US)

(21) Appl. No.: 13/287,952

(22) Filed: Nov. 2, 2011

(51) Int. Cl. H04W 36/14

(52) U.S. Cl. 455/436

(57) ABSTRACT

A method for transitioning across multiple radio access technologies is provided. The method comprises associating a first base station identification with a first radio access technology and associating a second base station identification with a second radio access technology. A co-layered relationship is then established between the first base station and first radio access technology and the second base station identification and second radio access technology and stored in a storage device, such as a memory, using the base station identification. The mobile device then searches for the co-layered relationship using the base station identification as a key and then retrieves the stored co-layer relationship. Once the mobile station has retrieved the stored co-layer relationship it utilizes the co-layered relationship to transition from the first radio access technology to the second radio access technology.

### BACKGROUND

1. Field

The present disclosure relates generally to communication systems, and more particularly, to locating co-layer network, multi-radio access technology serving base stations.

2. Background

Wireless communication systems are widely used to provide a variety of communication services such as voice, data, broadcast, and others. These communication systems may be multiple-access systems supporting simultaneous resource use by multiple users. This resource sharing is accomplished through the use of shared system resources, including bandwidth and transmit power. A number of multiple access systems are currently in use and include code division multiple access (CDMA), time division multiple access (TDMA), frequency division multiple access (FDMA), and orthogonal frequency division multiple access (OFDMA). These access systems may be used in conjunction with various communication standards such as those promulgated by 3GPP Long Tenn Evolution (4G LTE). LTE is an emerging telecommunication standard and is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), single carrier frequency division multiple access (SC-FDMA) on the uplink (UL), and multiple-input multiple-output (MIMO) antenna technology.

Wireless multiple access communication systems typically support multiple wireless terminals. Each wireless terminal, also known as a mobile stations (MS) or user equipment (UE), communicates with one or more base stations using forward and reverse links. The forward link refers to communication link from the base stations to the mobile terminals or UEs, and may also be known as the downlink. The reverse link refers to the communication link from the UEs to the base stations (BS). The communication link may be established by a single link system or a MIMO system.

The traffic generated by the UEs and BSs is managed in part by a serving network controller, which serves as the arbiter of wireless traffic. The network controller can send control information to UEs, assign wireless resources to UEs, manages uplink and downlink interference, and coordinates MIMO transmissions among neighboring BSs. The serving network controller acts as a central planner for managing the disparate wireless communications and ensures consistency and reliability.

A mobile station may move from an area using one radio access technology (RAT) to an area supported by another RAT. Before the MS moves out of the first area, the BS initiates action by instructing the MS to perform a handoff of cell change to a different RAT using a MS initiated and BS assisted approach. The BS broadcasts the co-layer information on the multiple RATs so that the MS may use this information to complete the handover to a different radio access technology in an expeditious manner. If the MS initiates the process, the MS must scan for active RATs as well as the multi-radio access technology. This requires additional time for the MS to make the switch to the new radio access technology. There is a need for a method, apparatus, and system to efficiently hand off a MS between radio access technologies.

### SUMMARY

A method for transitioning across multiple radio access technologies is provided. The method comprises the steps of associating a first base station identification with a first radio access technology and associating a second base station identification with a second radio access technology. Once the associations are made a co-layered relationship is established between the first base station and first radio access technology and the second base station identification and second radio access technology. The co-layered relationship is then stored in a storage device, such as a memory, using the base station identification. The mobile device may then search for the co-layered relationship in the storage device using the base station identification as a key. The storage device may be accessed by the mobile device and retrieve the stored co-layer relationship using the base station identification as the key. Once the mobile station has retrieved the stored co-layer relationship it utilizes the co-layered relationship to transition from the first radio access technology to the second radio access technology.

A further embodiment provides a method comprising acquiring co-layered base station information from multiple radio access technologies that are deployed on multiple base stations. A mobile device may then search for the co-layered multiple radio access technology base station identification. The mobile station then searches for the co-layered multiple radio access technology system information and stores both the co-layered base station system information from multiple radio access technologies and the co-layered multiple radio access technology system information using the base station identification as a key. The mobile station then transitions across multiple radio access technologies using the stored co-layer base station identification and radio access technology system information.

An apparatus is also provided and consists of a mobile station for communicating over a wireless network and a processor for associating co-layered system information with at least one base station using a base station identifier that is associated with the base station. A processor is used for searching for the co-layered system information using the base station identification. A memory is also provided for storing the co-layered system information using a base station identifier.

Yet a further embodiment provides an apparatus for transitioning across multiple radio access technologies and comprises: means for associating a first base station identification with a first radio access technology; means for associating a second base station identification with a second radio access technology; means for establishing a co-layered relationship between the associated first base station and first radio access technology and the associated second base station identification and second radio access technology; means for storing the co-layered relationship in a storage device, such as a memory, using a base station identification. The apparatus also provides means for searching by a mobile station for the co-layered relationship base station identification using the base station identification as a key; means for accessing the storage device and retrieving the co-layered relationship by the mobile device using the base station identification as a key; and means for utilizing the co-layered relationship to transition from the first radio access technology to the second radio access technology.

A yet further embodiment provides an apparatus comprising means for acquiring co-layered base station system information from multiple radio access technologies deployed on multiple base stations. The apparatus also includes means for searching for the co-layered multiple radio access technology base station identification and means for searching for co-layered multiple radio access technology system information. The apparatus further incorporates means for storing the co-layered base station system information from multiple radio access technologies and the co-layered multiple radio access technology system information using the base station identification as a key; and also includes means for transitioning across multiple radio access technologies using the stored co-layer base station identification and radio access technology system information.

A still further embodiment provides a non-transitory computer readable medium comprising instructions, which when executed by a processor cause the processor to perform the following operations: associate a first base station identification with a first radio access technology; associate a second base station identification with a second radio access technology; establish a co-layered relationship between the associated first base station and first radio access technology and the associated second base station identification and second radio access technology; store the co-layered relationship in a storage device using the base station identification. The instructions then cause the processor to search for the co-layered base station identification using the base station identification as a key and access the storage device to retrieve the co-layered relationship using the base station identification as the key. The instructions then provides for the utilization of the co-layered relationship to transition from the first radio access technology to the second radio access technology.

An additional embodiment provides a computer-readable medium that comprises instructions, which when executed by a processor cause the processor to perform the following operations: acquire co-layered base station system information from multiple radio access technologies that are deployed on multiple base stations; search for co-layered multiple radio access technology base station identification and then store the co-layered base station system information from the multiple radio access technologies and the co-layered multiple radio access technology system information using the base station identification as a key; and then use the information to transition across multiple radio access technologies using the stored co-layer base station identification and radio access technology system information.

### BRIEF DESCRIPTION OF THE DRAWINGS

FIG. 1 is a diagram illustrating an example of a hardware implementation for an apparatus employing a processing system.

FIG. 2 is a drawing of a wireless peer-to-peer communications system.

FIG. 3 is a diagram illustrating an example of a network architecture.

FIG. 4 is a diagram illustrating an example of an access network.

FIG. 5 is a flowchart illustrating a method for locating a co-layered multiple radio access technology serving base station identification.

FIG. 6 shows a cell coverage area showing a deployed WiMAX network.

FIG. 7 shows a geographical area with a 3GPP2 network deployed in a different area.

FIG. 8 illustrates a MS moving from a WiMAX network coverage area toward a 3GPP2 network coverage area.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Those skilled in the art will recognize how best to implement the described functionality presented throughout this disclosure depending on the particular application and the overall design constraints imposed on the overall system.

As those skilled in the art will readily appreciate from the detailed description to follow, the various concepts presented herein are well suited for WiMax applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), LTE, IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

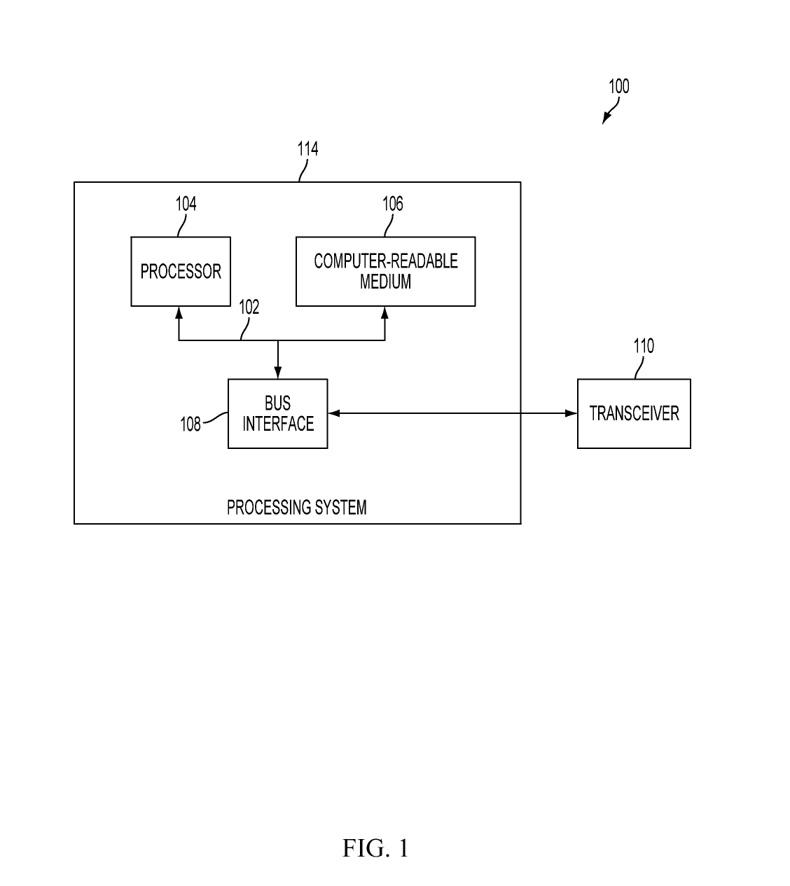

FIG. 1 is a conceptual diagram illustrating an example of a hardware implementation for an apparatus 100 employing a processing system 114. The processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors and/or hardware modules, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatuses over a transmission medium.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

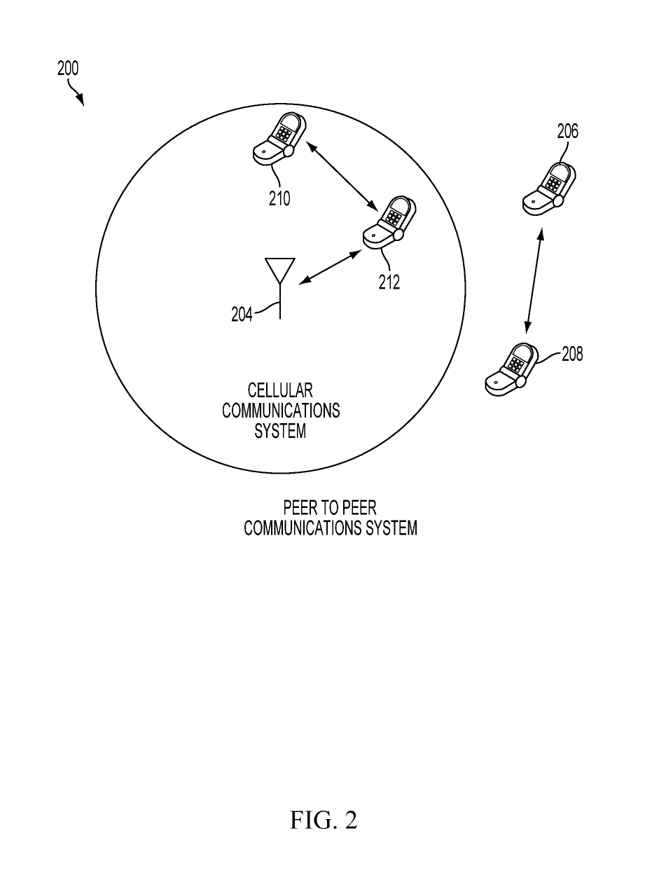

FIG. 2 is a drawing of an exemplary peer-to-peer communications system 200. The peer-to-peer communications system 200 includes a plurality of wireless devices 206, 208, 210, 212. The peer-to-peer communications system 200 may overlap with a cellular communications system, such as for example, a wireless wide area network (WWAN). Some of the wireless devices 206, 208, 210, 212 may communicate together in peer-to-peer communication, some may communicate with the base station 204, and some may do both. For example, as shown in FIG. 2, the wireless devices 206, 208 are in peer-to-peer communication and the wireless devices 210, 212 are in peer-to-peer communication. The wireless device 212 is also communicating with the base station 204.

The wireless device may alternatively be referred to by those skilled in the art as user equipment, a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless peer-to-peer communications systems, such as for example, a wireless peer-to-peer communication system based on FlashLinQ, WiMedia, Bluetooth, ZigBee, or Wi-Fi based on the IEEE 802.11 standard. The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDM) networks, Single Carrier FDMA (SC-FDMA) networks, among others. A CDMA network can implement a radio technology such as Universal Terrestrial Radio Access (UTRA), CDMA2000, and other technologies. UTRA includes Wideband CDMA (W-CDMA) and Low Chip Rate (LCR). CDMA2000 covers IS-2000, IS-95, and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, and others. UTRA, E-UTRA, and GSM are part of the Universal Mobile Telecommunication System (UMTS). Long Term Evolution (LTE) is a release of UMTS that uses E-UTRA. UTRA, E-UTRA, GSM, UMTS, and LTE are described in specifications issued by the “3^{rd} Generation Partnership Project” (3GPP). CDMA2000 is described in the specification promulgated by the Generation Partnership Project 2” (3GPP2). However, one of ordinary skill in the art would understand that the exemplary methods and apparatuses are applicable more generally to a variety of other wireless peer-to-peer communication systems.

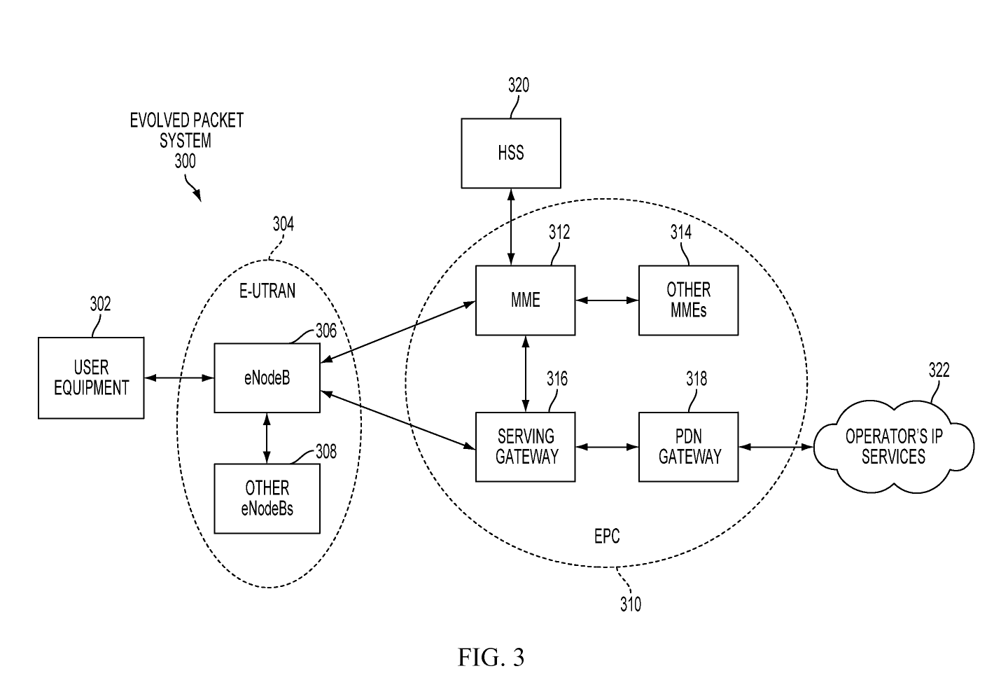

FIG. 3 is a diagram illustrating an LTE network architecture 300 employing various apparatuses 100 (See FIG. 1). The LTE network architecture 300 may be referred to as an Evolved Packet System (EPS) 300. The EPS 300 may include one or more user equipment (UE) 302, an Evolved UMTS Terrestrial Radio Access Network (E-UTRAN) 304, an Evolved Packet Core (EPC) 310, a Home Subscriber Server (HSS) 320, and an Operator's IP Services 322. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 306 and other eNBs 308. The eNB 306 provides user and control plane protocol terminations toward the UE 302. The eNB 306 may be connected to the other eNBs 308 via an X2 interface (i.e., backhaul). The eNB 306 may also be referred to by those skilled in the art as a base station, a base transceiver station, a radio base station, a radio transceiver, a transceiver function, a basic service set (BSS), an extended service set (ESS), or some other suitable terminology. The eNB 306 provides an access point to the EPC 310 for a UE 302. Examples of UEs 302 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 302 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 306 is connected by an 51 interface to the EPC 310. The EPC 310 includes a Mobility Management Entity (MME) 212, other MMEs 314, a Serving Gateway 316, and a Packet Data Network (PDN) Gateway 318. The MME 312 is the control node that processes the signaling between the UE 302 and the EPC 310. Generally, the MME 312 provides bearer and connection management. All user IP packets are transferred through the Serving Gateway 316, which itself is connected to the PDN Gateway 318. The PDN Gateway 318 provides UE IP address allocation as well as other functions. The PDN Gateway 318 is connected to the Operator's IP Services 322. The Operator's IP Services 322 include the Internet, the Intranet, an IP Multimedia Subsystem (IMS), and a PS Streaming Service (PSS).

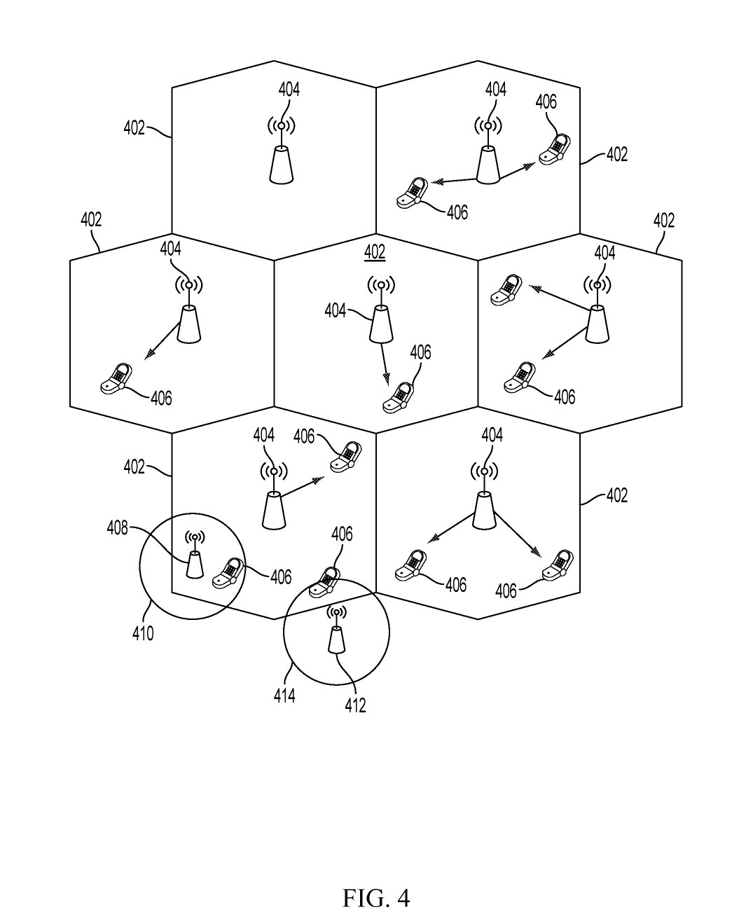

FIG. 4 is a diagram illustrating an example of an access network in an LTE network architecture. In this example, the access network 400 is divided into a number of cellular regions (cells) 402. One or more lower power class eNBs 408, 412 may have cellular regions 410, 414, respectively, that overlap with one or more of the cells 402. The lower power class eNBs 408, 412 may be femto cells (e.g., home eNBs (HeNBs)), pico cells, or micro cells. A higher power class or macro eNB 404 is assigned to a cell 402 and is configured to provide an access point to the EPC 310 for all the UEs 406 in the cell 402. There is no centralized controller in this example of an access network 400, but a centralized controller may be used in alternative configurations. The eNB 404 is responsible for all radio related functions including radio bearer control, admission control, mobility control, scheduling, security, and connectivity to the serving gateway 316 (see FIG. 3).

The modulation and multiple access scheme employed by the access network 400 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 404 may have multiple antennas supporting MIMO technology. The use of MIMO technology enables the eNB 404 to exploit the spatial domain to support spatial multiplexing, beamforming, and transmit diversity.

Spatial multiplexing may be used to transmit different streams of data simultaneously on the same frequency. The data steams may be transmitted to a single UE 406 to increase the data rate or to multiple UEs 406 to increase the overall system capacity. This is achieved by spatially precoding each data stream and then transmitting each spatially precoded stream through a different transmit antenna on the downlink. The spatially precoded data streams arrive at the UE(s) 406 with different spatial signatures, which enables each of the UE(s) 406 to recover the one or more data streams destined for that UE 406. On the uplink, each UE 406 transmits a spatially precoded data stream, which enables the eNB 404 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

As wireless technology has grown and developed more mobile stations are capable of utilizing one or more of the radio access technologies described above. When a multi-mode mobile station moves out of the service of the currently active radio technology, it must locate a co-layer network in order to continue the call or data exchange. Before the mobile station moves out of the service area of the current radio access technology, the base station initiates action by instructing the mobile station to perform a hand off or to change to a different cell that utilizes a different radio access technology. This approach is considered a mobile station initiated and base station assisted approach. If the mobile station initiates the procedure, it must scan for the active radio access technology as well as the multi-radio access technology, which takes additional time, and delays the switch to another radio access technology and cell.

In order to speed up the transition from one radio access technology to another, an access on demand approach is used. This approach is initiated by the mobile station without the assistance of the base station. The co-layered base station system information is stored in a network accessible data server or in a portable memory storage device, the mobile station's own internal storage memory, or any other suitable storage device. This information may be prepared in advance by the network operator, or may be derived by the mobile station.

The mobile station may derive the co-layered base station system information by visiting the network coverage area or by listening to the downlink system information broadcast. Other methods of acquiring the co-layered base station information may be used.

When the mobile station moves out of the service area for the original radio access technology, the mobile station may use the methods described below to by the scan of multiple radio access technologies and the related system acquisition process, thus speeding up the multiple radio access technology or cell selection process without the assistance or involvement of the network.

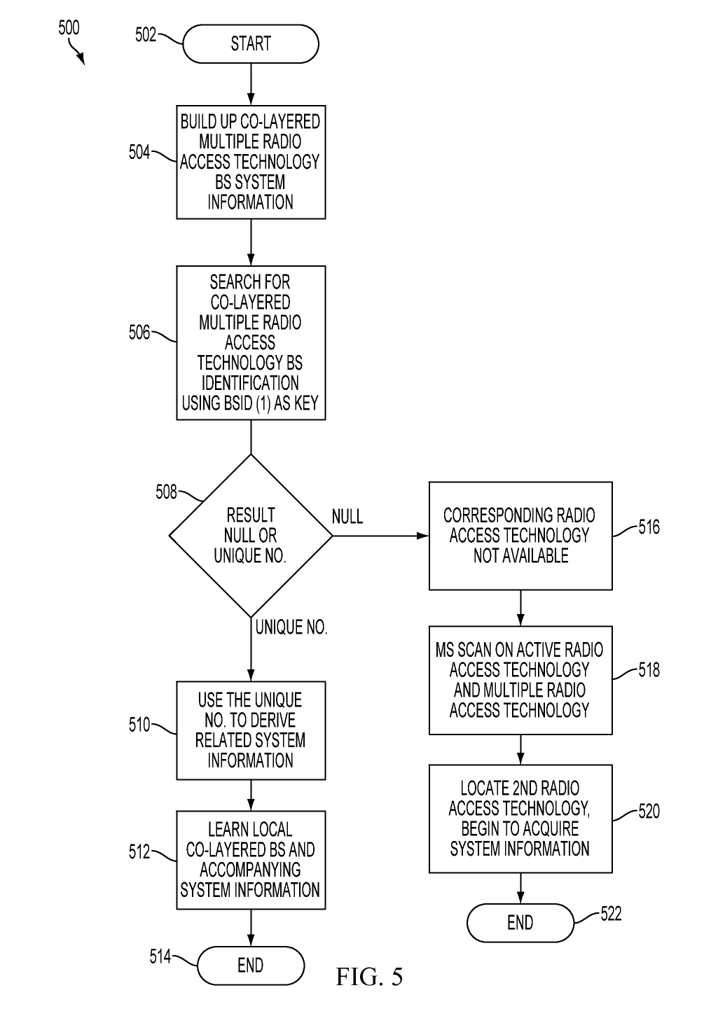

FIG. 5 depicts the steps of a method for locating co-layer network, multi-radio access technology serving base station identification. The method, 500, begins with the start block, 502. At this point, the mobile station is moving toward the cell boundary of one radio access technology and is about to cross out of the service area for that radio access technology. The first step of the method involves building up the co-layered multiple radio access technology base station system information, in step 504. An area that may be covered by WiMAX may also be covered by LTE. In this situation, radio access technology base station signals are decodable to a multi-mode mobile station. Radio access technology BS 1, and radio access technology BS 2 are decodable by a multi-mode mobile station. Radio access technology BS 1 is the active radio access technology serving base station. In this co-layered system information can be associated with the respective base station using the base station identification (BSID) as the key. This relationship may be expressed as follows:
Co-layered relationship (RAT(1), RAT (2) . . . , RAT (n))=[BSID (1), BSID (2) . . . , BSID (n)].
If a radio access technology is not used in that geographical area of cell, then the entry is set as NULL.

In step 506 the search for the co-layered multiple radio access technology base station identification occurs. As an example, assume that the current radio access technology is RAT (1) with the serving base station identification of BSID (1). To derive the co-layered base station identification, the mobile station can use BSID (1) as the key to search for a co-layered relationship. Because the base station identification for each radio access technology is unique, no ambiguous results appear in the search results, in step 508. As a result, the results returned are either NULL or a unique number. If the result is NULL, then the corresponding radio access technology is not available in the area in question, as noted in step 516. When that occurs, the mobile station must scan on an active radio access technology, as described further below.

When step 508 returns a base station identification that is not NULL, the mobile station uses this information as the search index to derive the related system information from the data storage, in step 510. When the search process of step 506 is complete, the mobile station may bypass the multiple radio access technology radio frequency scan process, saving time.

In step 512 the mobile station learns the local co-layered base station and its accompanying system information. When the associated co-layered relationship information is not available, that is, step 508 produced a NULL result, in step 516 the mobile station learns that the corresponding radio access technology is not available. At this point, the mobile station encounters out of service information and is forced to scan on the active radio access technology in addition to the multiple radio access technology, in step 518.

After scanning and locating a second radio access technology and associated base station RAT (2) in step 520, the mobile station derives a set of base stations with the strongest signals and locates a base station with a strong signal, BSID (2). The mobile station listens to this base station to acquire the system information and once the acquisition process is complete, the process ends at step 522.

In order to prevent a future out of service problem, the mobile station first establishes the co-layered relationships RAT (1), RAT (2), . . . RAT (n)=[BSID (1), BSID (2), NULL, . . . NULL] and then stores BSID (2) system information under the key BSID (2).

If a third radio access technology is available, RAT (3), with BSID (3) providing strong signals, then the mobile station uses the process above to establish a co-layered relationship RAT (1), RAT (2), RAT (n)=[BSID (1), BSID (2), BSID (3)]. The mobile station continues to use the approach described to connect the co-layered multiple radio access technology system information together.

The base station assisted co-layered base station system information broadcasting method broadcasts all of the co-layered multiple radio access technology base station system information from the short range protocols to the long range wireless protocols used in 2G, 3G, and 4G systems. The co-layered multiple radio access technology system information is broadcast on a repeated schedule. This reduces the bandwidth used for data communication. In addition, the mobile station saves time because it is not repeatedly decoding the same broadcast and system information for radio access technologies it does not need.

The described method may also be implemented using a tunneling protocol, allowing the mobile station to request the co-layered multiple radio access technology in an on-demand manner. The mobile station may also request the co-layered multiple radio access technology system information for neighboring cells or may request visiting co-layered multiple radio access technology neighbor cell's system information. If tunneling is not supported by the serving base station, the mobile station may use the data connection to connect to a public search engine and derive a similar result.

If the mobile station loses the active wireless connection on the active radio access technology, the mobile station may use local memory to search for the complete or simplified version of the co-layered multiple radio access technology neighbor cell system information.

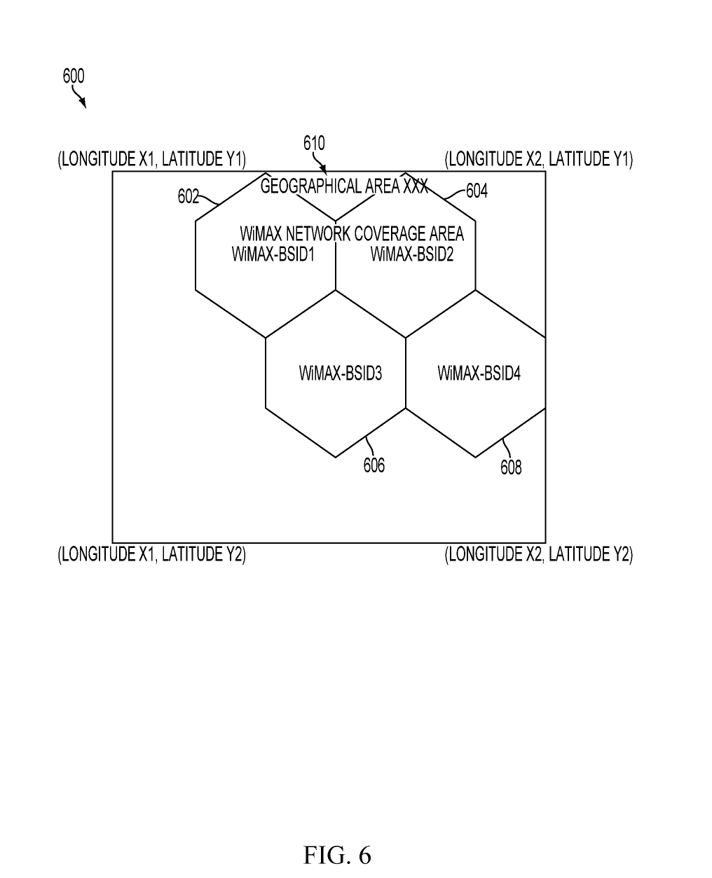

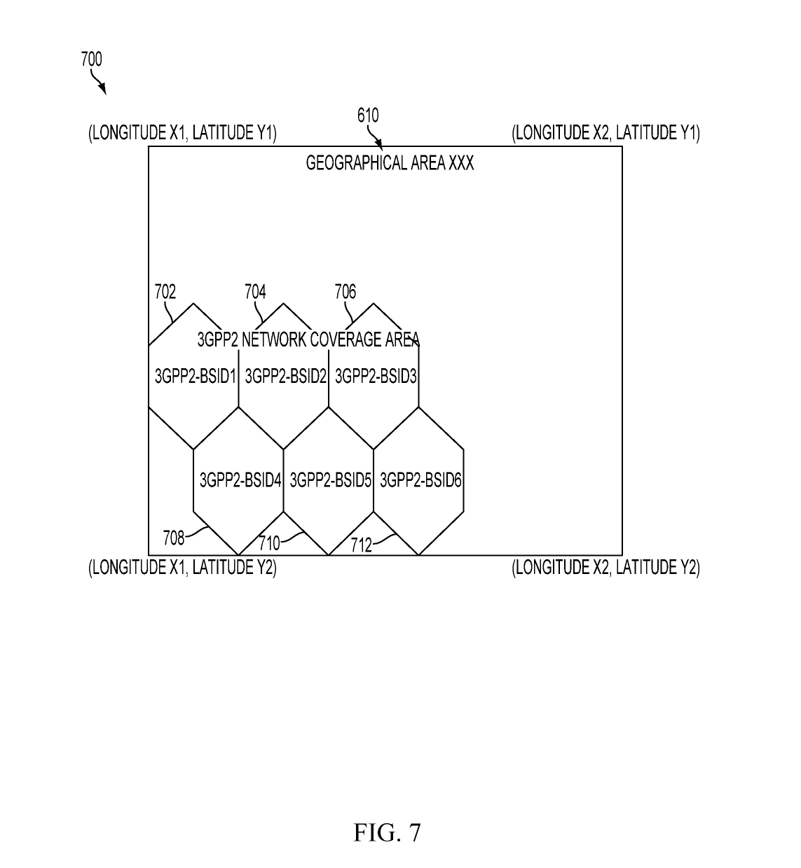

FIG. 6 and FIG. 7 depict a geographical area XXX located at a specific latitude and longitude (longitude 1, latitude 1), (longitude 1, latitude 2), (longitude 2, latitude 1), (longitude 2, latitude 2). Two different radio access technologies are deployed in area XXX, WiMAX and CDMA. FIG. 6 shows a geographical area 600 located at specific latitude and longitude. Geographical area XXX is denoted as 610 in FIG. 6 and FIG. 7. A portion of the area 600 is covered by WiMAX and includes cells 602, 604, 606, and 608.

FIG. 7 also depicts area 610 and shows the deployment of a 3GPP2 network in a different portion of area 610. The 3GPP2 network includes cells 702, 704, 706, 708, 710, and 712. The WiMAX area of FIG. 6 is co-layered with the 3GPP2 area of FIG. 7. As is evident from FIG. 6 and FIG. 7, a portion of the area 610 is covered by WiMAX, another portion of the area is covered by CDMA, while another area is co-layered and is covered by both radio access technologies.

The mobile station may move from a WiMAX area to a CDMA coverage area. The mobile station uses the WiMAX serving BSID as the key to derive the co-layered CDMA base station system information when it crosses out of the WiMAX service area and moves into the CDMA service area.

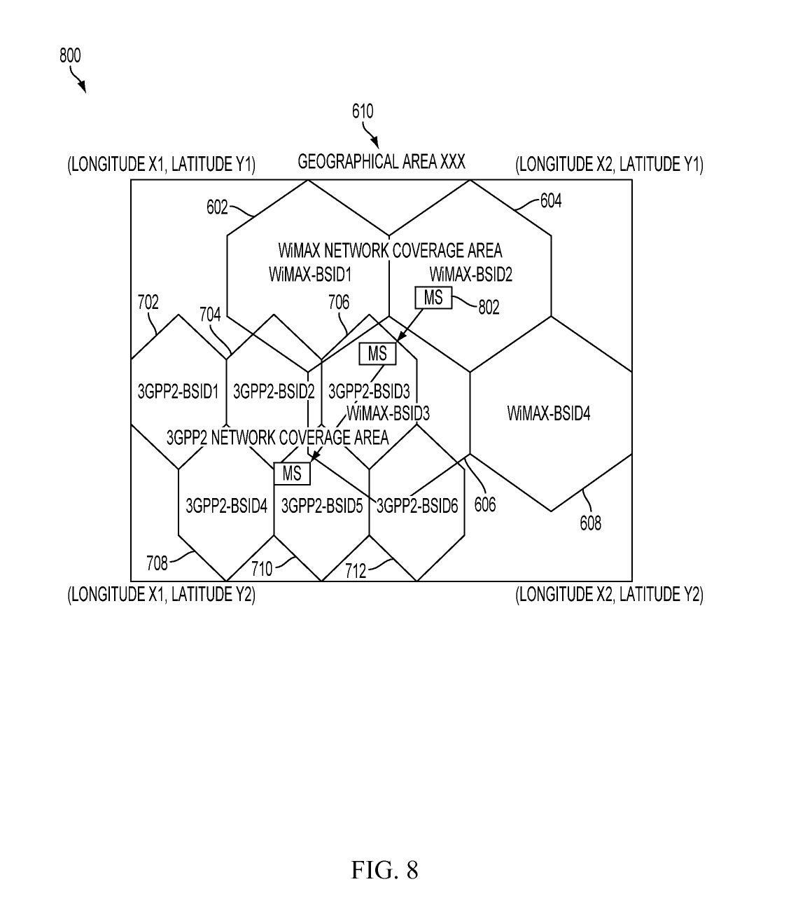

FIG. 8 depicts the mobile station 802, in system 800, moving from a WiMAX area 604 to an area not covered by WiMAX 710. During the movement, the mobile station 802 passes through a cell with a co-layered capability, 706. As the mobile station 802 moves it moves out of service of the WiMAX radio access technology in cell 604 and is out of service. When this occurs, the mobile station scans for multiple radio access technologies and identifies a 3GPP2 base station with identification BSID 5, in cell 710. The mobile station 802 has already stored the information that the last serving base station identification is BSID 3. The mobile station 802 then stores the relationship information [WiMAX-BSID 3, 3GPP2-BSID 5] in its long term memory. The mobile station 802 had previously stored the 3GPP2-BSID 3 information. The next time the mobile station 802 traverses the same route and passes by the same base station, it can perform the multiple radio access technology measurement using the information already stored in memory to directly measure the co-layered WiMAX BSID 3, 3GPP2-BSID 5 relationship and may bypass the system information acquisition process.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Also, as used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of transitioning across multiple radio access technologies, comprising:
associating a first base station identification with a first radio access technology;
associating a second base station identification with a second radio access technology;
establishing a co-layered relationship between the associated first base station and first radio access technology and the associated second base station identification and second radio access technology;
storing the co-layered relationship in a storage device using a base station identification;
searching by a mobile station for the co-layered relationship base station identification using the base station identification as a key;
accessing the storage device and retrieving the co-layered relationship by the mobile device using the base station identification as the key; and
utilizing the co-layered relationship to transition from the first radio access technology to the second radio access technology.

2. The method of claim 1, further comprising scanning on the active radio access technology to derive a set of base stations and acquiring system information from the set of base stations.

3. The method of claim 2, further comprising storing the base station identification and associating the base station identification with a radio access technology used by the base station.

4. The method of claim 1, further comprising setting an entry to null in the co-layered relationship if a radio access technology is not supported by a base station.

5. The method of claim 4 further comprising: determining if a base station identification is null in the co-layered relationship and deriving related system information when the base station identification is not null.

6. The method of claim 1, further comprising: learning the local co-layered base station and related system information by a mobile station.

7. A method comprising:
acquiring co-layered base station system information from multiple radio access technologies deployed on multiple base stations;
searching for the co-layered multiple radio access technology base station identification by a mobile station;
searching for co-layered multiple radio access technology system information;
storing the co-layered base station system information from multiple radio access technologies and the co-layered multiple radio access technology system information using a base station identification as a key; and
transitioning across multiple radio access technologies using the stored co-layer base station identification and radio access technology system information.

8. An apparatus comprising:
a mobile station for communicating over a wireless network;
a processor for associating co-layered system information with at least one base station using a base station identifier associated with the base station;
a processor for searching for the co-layered system information using the base station identification; and
a memory for storing the co-layered system information using a base station identifier.

9. The apparatus of claim 8, wherein the processor for associating co-layered system information with at least one base station using a base station identifier associated with the base station and the processor for searching for the co-layered system information using the base station identification are one processor.

10. The apparatus of claim 8, wherein the memory for storing the co-layered system information using a base station identifier are located within the mobile station.

11. The apparatus of claim 8, wherein the memory for storing the co-located system information using a base station identifier are located within a base station.

12. A mobile station, comprising:
a processor for associating co-layered system information with at least one base station using a base station identifier associated with the base station;
a processor for searching for the co-layered system information using the base station identification; and
a memory for storing the co-located system information using a base station identifier.

13. The mobile station of claim 12, wherein the processor for associating co-layered system information with at least one base station using a base station identifier associated with the base station and the processor for searching for the co-layered system information using the base station identification are one processor.

14. An apparatus for transitioning across multiple radio access technologies, comprising:
means for associating a first base station identification with a first radio access technology;
means for associating a second base station identification with a second radio access technology;
means for establishing a co-layered relationship between the associated first base station and first radio access technology and the associated second base station identification and second radio access technology;
means for storing the co-layered relationship in a storage device using a base station identification;
means for searching by a mobile station for the co-layered relationship base station identification using the base station identification as a key;
means for accessing the storage device and retrieving the co-layered relationship by the mobile device using the base station identification as a key; and
means for utilizing the co-layered relationship to transition from the first radio access technology to the second radio access technology.

15. The apparatus of claim 14, further comprising means for scanning on the active radio access technology to derive a set of base stations and acquiring system information from the set of base stations.

16. The apparatus of claim 15, further comprising means for storing the base station identification and associating the base station identification with a radio access technology used by the base station.

17. The apparatus of claim 14, further comprising means for setting an entry to null in the co-layered relationship if a radio access technology is not supported by the base station.

18. The apparatus of claim 17, further comprising means for determining if a base station identification is null in the co-layered relationship and deriving related system information when the base station identification is not null.

19. The apparatus of claim 14, further comprising means for learning the local co layered base station and related system information.

20. An apparatus, comprising:
means for acquiring co-layered base station system information from multiple radio access technologies deployed on multiple base stations;
means for searching for the co-layered multiple radio access technology base station identification by a mobile station;
means for searching for co-layered multiple radio access technology system information;
means for storing the co-layered base station system information from multiple radio access technologies and the co-layered multiple radio access technology system information using a base station identification as a key; and
means for transitioning across multiple radio access technologies using the stored co-layer base station identification and radio access technology system information.

21. A non-transitory computer-readable medium comprising instructions, which when executed by a processor causes the processor to perform the following operations:
associate a first base station identification with a first radio access technology;
associate a second base station identification with a second radio access technology;
establish a co-layered relationship between the associated first base station and first radio access technology and the associated second base station identification and second radio access technology;
store the co-layered relationship in a storage device using a base station identification;
search for the co-layered relationship base station identification using the base station identification as a key;
access the storage device and retrieve the co-layered relationship using the base station identification as the key; and
utilize the co-layered relationship to transition from the first radio access technology to the second radio access technology.

22. The non-transitory computer-readable medium of claim 21, further comprising scan on the active radio access technology to derive a set of base stations and acquiring system information from the set of base stations.

23. The non-transitory computer readable medium of claim 22, further comprising store the base station identification and associated the base station identification with a radio access technology used by the base station.

24. The non-transitory computer readable medium of claim 21, further comprising set an entry to null in the co-layered relationship if a radio access technology is not supported by the base station.

25. The non-transitory computer-readable medium of claim 24, further comprising determine if a base station identification is null in the co-layered relationship and deriving related system information when the base station identification is not null.

26. The non-transitory computer-readable medium of claim 21, further comprising learn the local co-layered base station and related system information.

27. A non-transitory computer-readable medium comprising instructions, which when executed by a processor cause the processor to perform the following operations:
acquire co-layered base station system information from multiple radio access technologies deployed on multiple base stations;
search for co-layered multiple radio access technology base station identification;
store the co-layered base station system information from multiple radio access technologies and the co-layered multiple radio access technology system information using a base station identification as a key; and
transition across multiple radio access technologies using the stored co-layer base station identification and radio access technology system information.
